(19) United States
(12) Patent Application Publication
(10) Pub. No.: US 2017/0054500 A1
(43) Pub. Date: Feb. 23, 2017

(54) Visible Light Communications VLC Related Device and Method

(71) Applicant: Huawei Technologies Co., Ltd., Shenzhen (CN)

(72) Inventor: Lu Rong, Shanghai (CN)

(21) Appl. No.: 15/343,287

(22) Filed: Nov. 4, 2016

Related U.S. Application Data
(63) Continuation of application No. PCT/CN2014/076790, filed on May 5, 2014.

(51) Int. Cl. H04B 10/116; H04L 5/00

(52) U.S. Cl. CPC H04B 10/116; H04L 5/0055

(57) ABSTRACT

A visible light communications VLC related device and method is presented. In embodiments in which a terminal can receive only visible light data, the terminal can feed back data to a VLC device, thereby implementing bidirectional data transmission. In the method, the terminal feeds back uplink data to the visible light communications device using a wireless communication signal, to implement bidirectional data transmission in a visible light communication scenario.

### CROSS-REFERENCE TO RELATED APPLICATIONS

This application is a continuation of International Application No. PCT/CN2014/076790, filed on May 5, 2014, the disclosure of which is hereby incorporated by reference in its entirety.

### TECHNICAL FIELD

The present disclosure relates to the field of communications technologies, and in particular, to a visible light communications (VLC) related device and method.

### BACKGROUND

VLC is a communication manner in which communication and data transmission are performed using visible light, and can achieve a data transmission rate of 1 Gigabit per second (Gbps). Visible light communications technologies can make full use of lamplight and provide high-rate data transmission at the same time of illumination. Currently, practical visible light communication is performed mainly based on white light, such as white light emitted by a light emitting diode (LED). It is estimated that by 2021, the LED will account for more than 50% of the global market for lamps in the commercial sector. Therefore, the visible light communications may develop from a laboratory product to a commercial product and enters a rapid development period, and has extensive market prospects.

At home and abroad, the field of visible light communications is still at a research and pilot manufacturing stage, and neither a superspeed visible light communications technology nor a related terminal product has been implemented yet.

Institute of Electrical and Electronics Engineers (IEEE) 802.15.7 is a set of standard for visible light communications, and defines standard interfaces among a physical layer, a media access control (MAC) layer, and a logical link control (LLC) layer of the visible light communications. The 802.15.7 protocol supports bidirectional visible light communication, and feedback information is transmitted by means of a reverse visible light link.

In an actual scenario, visible light may be used to transmit downlink (DL) data to a user. However, because visible light communications has such problems as high power consumption on sending and low transmission efficiency, data sending by means of visible light is unsuitable for a terminal device (also referred to as “user equipment” (UE)) such as a mobile phone of the user. Consequently, the terminal can receive only visible light data, but cannot feed back data to a VLC device, and hence it is hard to implement bidirectional communication, limiting an application of the visible light communications.

### SUMMARY

Embodiments of the present disclosure provides a visible light communications VLC related device and method, so that in a case in which a terminal can receive only visible light data, the terminal can feed back data to a VLC device, thereby implementing bidirectional data transmission.

According to a first aspect, the present disclosure provides a terminal, including a visible light communications VLC receiving module configured to receive a data packet that is transmitted using a visible light link, where the data packet carries a data packet identifier; an LLC entity module configured to generate acknowledgement information according to the data packet received by the VLC receiving module, where the acknowledgement information carries the data packet identifier of the successfully received data packet; and a wireless communications module configured to send a wireless communication signal that carries the acknowledgement information generated by the LLC entity module.

With reference to the first aspect, in a first possible implementation manner, the wireless communications module is configured to send a WiFi signal, a Bluetooth® signal, or an infra-red (IR) signal that carries the acknowledgement information generated by the LLC entity module; or send a cellular wireless communication signal that carries the acknowledgement information generated by the LLC entity module.

According to a second aspect, the present disclosure provides a visible light communications VLC device, including a communications module configured to receive a communication signal that carries acknowledgement information, where the acknowledgement information carries a data packet identifier of a data packet that is successfully received by a terminal and that is transmitted using a visible light link; an LLC entity module configured to obtain, according to the acknowledgement information received by the communications module, the data packet identifier of the data packet successfully received by the terminal; and a VLC transmit module configured to transmit a data packet to the terminal using the visible light link, where the transmitted data packet does not include the data packet that corresponds to the data packet identifier obtained by the LLC entity module.

With reference to the second aspect, in a first possible implementation manner, the communications module is configured to receive a WiFi signal, a Bluetooth signal, or an IR signal that carries the acknowledgement information; or receive a cellular wireless communication signal that carries the acknowledgement information.

With reference to the second aspect, in a second possible implementation manner, the communications module is configured to receive an acknowledgement notification message that is sent by a wireless communications device and that carries the acknowledgement information, where the acknowledgement information carries the data packet identifier of the data packet that is successfully received by the terminal and that is transmitted using the visible light link, and the acknowledgement notification message is generated and sent by the wireless communications device after the wireless communications device receives a wireless communication signal that is sent by the terminal and that carries the acknowledgement information.

With reference to second possible implementation manner of the second aspect, in a third possible implementation manner, the communications module is connected to the wireless communications device using any one of an Ethernet communications link, a power line communications link, or a wireless communications link.

According to a third aspect, the present disclosure provides a wireless communications device, including a receiver configured to receive a wireless communication signal that is sent by a terminal and that carries acknowledgement information, where the acknowledgement information carries a data packet identifier of a data packet that is successfully received by the terminal and that is transmitted using a visible light link; and obtain the acknowledgement information; an LLC entity module configured to obtain the data packet identifier that is carried in the acknowledgement information obtained by the receiver, and generate an acknowledgement notification message carrying the obtained data packet identifier; and a transmitter configured to send the acknowledgement notification message generated by the LLC entity module to a visible light communications device.

With reference to the third aspect, in a first possible implementation manner, the receiver is configured to receive a WiFi signal, a Bluetooth signal, or an IR signal that is sent by the terminal and that carries the acknowledgement information; or receive a cellular wireless communication signal that is sent by the terminal and that carries the acknowledgement information.

With reference to the third aspect or the first possible implementation manner, in a second possible implementation manner, the wireless communications device has a WiFi function; or a Bluetooth function; or an IR function; or a cellular wireless communication capability.

According to a fourth aspect, the present disclosure provides a visible light communication method, including receiving a data packet that is transmitted by a visible light communications device using a visible light link, where the data packet carries a data packet identifier; generating acknowledgement information according to the successfully received data packet, where the acknowledgement information carries the data packet identifier of the successfully received data packet; and sending a wireless communication signal that carries the acknowledgement information.

With reference to the fourth aspect, in a first possible implementation manner, the sending a wireless communication signal that carries the acknowledgement information includes sending a WiFi signal, a Bluetooth signal, or an IR signal that carries the acknowledgement information; or sending a cellular wireless communication signal that carries the acknowledgement information.

With reference to the fourth aspect or the first possible implementation manner, in a second possible implementation manner, the sending a wireless communication signal that carries the acknowledgement information includes sending the wireless communication signal that carries the acknowledgement information to a wireless communications device, so that the wireless communications device forwards the acknowledgement information to the visible light communications device; or sending the wireless communication signal that carries the acknowledgement information to the visible light communications device.

According to a fifth aspect, the present disclosure provides a visible light communication method, including sending a data packet to a terminal using a visible light link; and receiving a wireless communication signal that carries acknowledgement information returned by the terminal, where the acknowledgement information carries a data packet identifier of the data packet successfully received by the terminal.

With reference to the fifth aspect, in a first possible implementation manner, the receiving a wireless communication signal that carries acknowledgement information returned by the terminal includes receiving a WiFi signal, a Bluetooth signal, or an IR signal that carries the acknowledgement information returned by the terminal; or receiving a cellular wireless communication signal that carries the acknowledgement information returned by the terminal.

With reference to the fifth aspect or the first possible implementation manner, in a second possible implementation manner, the method further includes obtaining the data packet identifier carried in the acknowledgement information, and sending a data packet to the terminal, where the sent data packet does not include the data packet corresponding to the obtained data packet identifier.

According to a sixth aspect, the present disclosure provides a visible light communication method, including sending a data packet to a terminal using a visible light link; and receiving acknowledgement information of the terminal using a logical link control entity, where the acknowledgement information carries a data packet identifier of the data packet successfully received by the terminal, and the acknowledgement information is forwarded by a wireless communications device after the wireless communications device obtains the acknowledgement information from a received wireless communication signal sent by the terminal.

With reference to the sixth aspect, in a first possible implementation manner, that the wireless communications device obtains the acknowledgement information from the received wireless communication signal sent by the terminal includes the wireless communications device obtains the acknowledgement information from a received WiFi signal, Bluetooth signal, or IR signal that is sent by the terminal; or the wireless communications device obtains the acknowledgement information from a received cellular wireless communication signal sent by the terminal.

With reference to the sixth aspect or the first possible implementation manner, in a second possible implementation manner, that the wireless communications device forwards the acknowledgement information after obtaining the acknowledgement information from the received wireless communication signal sent by the terminal includes the wireless communications device forwards the acknowledgement information using any one of an Ethernet communications link, a power line communications link, or a wireless communications link.

Based on the foregoing technical solutions, in the embodiments of the present disclosure, in a scenario of visible light communication, a terminal feeds back uplink data to a visible light communications device using a wireless communication signal, so that in a case in which the terminal can receive only visible light data, the terminal can feed back data to the VLC device, thereby implementing bidirectional data transmission.

### BRIEF DESCRIPTION OF DRAWINGS

FIG. 1 is a schematic structural diagram of a terminal according to an embodiment of the present disclosure;

FIG. 2 is a schematic structural diagram of a VLC device according to an embodiment of the present disclosure;

FIG. 3 is a schematic structural diagram of a wireless communications device according to an embodiment of the present disclosure;

FIG. 4 is a schematic flowchart of a method for performing visible light communication by a terminal according to an embodiment of the present disclosure;

FIG. 5 is a schematic flowchart of a method for performing visible light communication by a VLC device according to an embodiment of the present disclosure;

FIG. 6 is a schematic flowchart of another method for performing visible light communication by a VLC device according to an embodiment of the present disclosure;

FIG. 7 is a schematic flowchart of a method for implementing bidirectional visible light communication according to an embodiment of the present disclosure; and

FIG. 8 is a schematic flowchart of another method for implementing bidirectional visible light communication according to an embodiment of the present disclosure.

### DESCRIPTION OF EMBODIMENTS

To make the objectives, technical solutions, and advantages of the present disclosure clearer, the following further describes the present disclosure in detail with reference to the accompanying drawings. The described embodiments are merely some but not all of the embodiments of the present disclosure. All other embodiments obtained by a person of ordinary skill in the art based on the embodiments of the present disclosure without creative efforts shall fall within the protection scope of the present disclosure.

As disclosed herein, after receiving a data packet that is transmitted by a visible light communications device using a visible light link, a terminal feeds back a reception status to the visible light communications device by means of a wireless communication function of the terminal other than a visible light communications function, thereby implementing bidirectional data transmission.

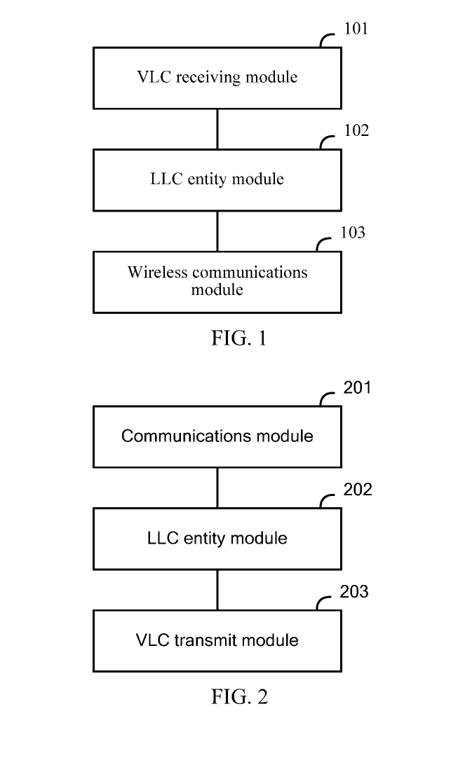

As shown in FIG. 1, a first embodiment of the present disclosure provides a terminal. The terminal mainly includes a visible light communications VLC receiving module 101 configured to receive a data packet that is transmitted using a visible light link, where the data packet carries a data packet identifier; and transmit the data packet to an LLC entity module; the LLC entity module 102 configured to generate acknowledgement information according to the data packet transmitted by the VLC receiving module 101, and transmit the acknowledgement information to a wireless communications module 103, where the acknowledgement information carries the data packet identifier of the successfully received data packet; and the wireless communications module 103 configured to send a wireless communication signal that carries the acknowledgement information transmitted by the LLC entity module 102.

Preferably, the wireless communications module 103 sends a WiFi signal, a Bluetooth signal, or an IR signal that carries the acknowledgement information generated by the LLC entity module 102; or sends a cellular wireless communication signal that carries the acknowledgement information generated by the LLC entity module.

When the wireless communications module of the terminal is a WiFi module, the wireless communications module adds the acknowledgement information to a WiFi signal; when the wireless communications module of the terminal is a Bluetooth module, the wireless communications module adds the acknowledgement information to a BT signal; or when the wireless communications module of the terminal is an IR module, the wireless communications module adds the acknowledgement information to an IR signal.

When the wireless communications module of the terminal has a cellular wireless communication capacity, the wireless communications module adds the acknowledgement information to a cellular wireless communication signal.

As shown in FIG. 2, a second embodiment of the present disclosure provides a visible light communications VLC device. The VLC device mainly includes a communications module 201 configured to receive a communication signal that carries acknowledgement information, where the acknowledgement information carries a data packet identifier of a data packet that is successfully received by the terminal and that is transmitted using a visible light link; and transmit the acknowledgement information to an LLC entity module 202; the LLC entity module 202 configured to obtain, according to the acknowledgement information transmitted by the communications module 201, the data packet identifier of the data packet successfully received by the terminal, and transmit the obtained data packet identifier to a VLC transmit module 203; and the VLC transmit module 203 configured to transmit a data packet to the terminal using the visible light link, where the transmitted data packet does not include the data packet that corresponds to the data packet identifier transmitted by the LLC entity module 202.

In an optional implementation manner, the communications module 201 receives a WiFi signal, a Bluetooth signal, or an IR signal that carries the acknowledgement information; or the communications module 201 receives a cellular wireless communication signal that carries the acknowledgement information.

In another optional implementation manner, the communications module 201 receives an acknowledgement notification message that is sent by a wireless communications device and that carries the acknowledgement information, where the acknowledgement information carries the data packet identifier of the data packet that is successfully received by the terminal and that is transmitted using the visible light link, and the acknowledgement notification message is generated and sent by the wireless communications device after the wireless communications device receives a wireless communication signal that is sent by the terminal and that carries the acknowledgement information.

In this optional implementation manner, the communications module 201 is connected to the wireless communications device using any one of an Ethernet communications link, a power line communications link, or a wireless communications link.

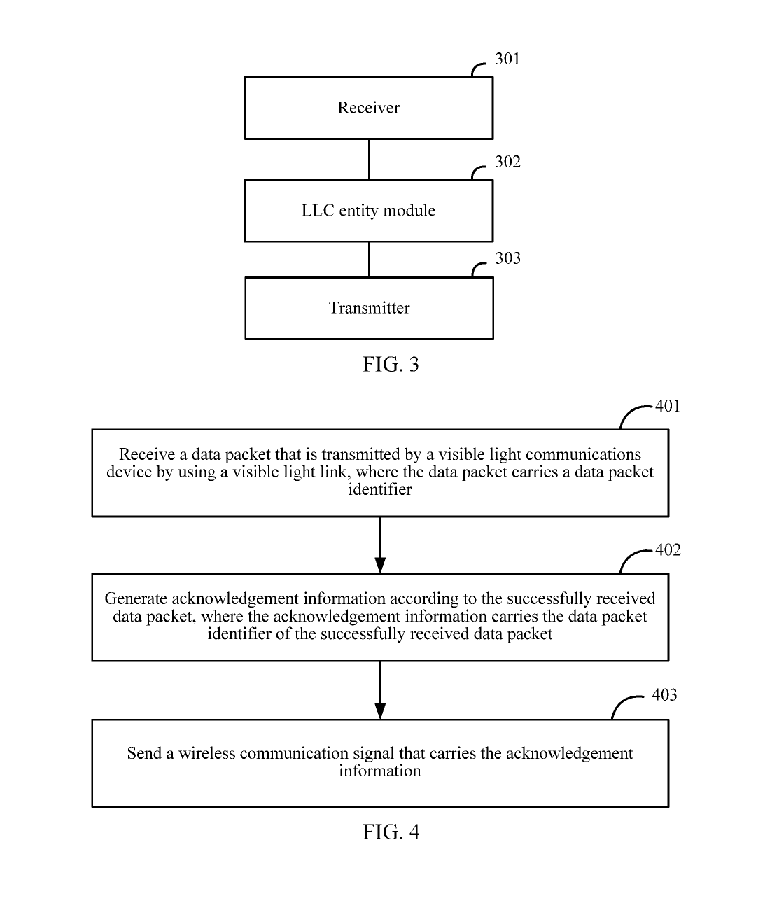

As shown in FIG. 3, a third embodiment of the present disclosure further provides a wireless communications device. The wireless communications device mainly includes a receiver 301 configured to receive a wireless communication signal that is sent by a terminal and that carries acknowledgement information, where the acknowledgement information carries a data packet identifier of a data packet that is successfully received by the terminal and that is transmitted using a visible light link; an LLC entity module 302 configured to obtain the data packet identifier that is carried in the acknowledgement information obtained by the receiver 301, and generate an acknowledgement notification message carrying the obtained data packet identifier; and a transmitter 303 configured to send the acknowledgement notification message generated by the LLC entity module 302 to a VLC device.

Preferably, the receiver 301 receives a WiFi signal, a Bluetooth signal, or an IR signal that carries the acknowledgement information; or receives a cellular wireless communication signal that carries the acknowledgement information.

A communications link used by the transmitter of the wireless communications device to send the acknowledgement notification message to the VLC device may be any one of an Ethernet communications link, a power line communications link, or a wireless communications link.

If a wireless communications module of the wireless communications device is a WiFi module, the received wireless communication signal is a WiFi signal; if a wireless communications module of the wireless communications device is a Bluetooth module, the received wireless communication signal is a Bluetooth signal; or if a wireless communications module of the wireless communications device is an IR module, the received wireless communication signal is an IR signal.

The receiver 301 of the wireless communications device has a cellular wireless communication capability, and the received wireless communication signal may be a cellular wireless communication signal. In specific implementation, the wireless communications device having the cellular wireless communication capability may be a small cell, a femto cell, or a high-frequency base station.

In specific implementation, the receiver and the transmitter in the wireless communications device may be separately implemented using independent hardware, or may be integrated into one transceiver. Any implementation manner shall fall within the protection scope of the present disclosure, as long as the implementation manner can implement the foregoing functions.

In a fourth embodiment of the present disclosure, as shown in FIG. 4, an execution body may be but is not limited to a terminal side, and a detailed process of a method for implementing visible light communication is as disclosed in the following steps.

Step 401: Receive a data packet that is transmitted by a visible light communications device using a visible light link, where the data packet carries a data packet identifier.

A VLC receiving module of the terminal receives the data packet that is transmitted by the VLC device using the visible light link, where the data packet carries the data packet identifier, and transmits the received data packet to an LLC entity module of the terminal.

Step 402: Generate acknowledgement information according to the successfully received data packet, where the acknowledgement information carries the data packet identifier of the successfully received data packet.

The LLC entity module of the terminal generates the acknowledgement (ACK) message according to the data packet transmitted by the VLC receiving module of the terminal, and transmits the acknowledgement information to a wireless communications module of the terminal, where the acknowledgement information carries the data packet identifier of the data packet successfully received by the terminal.

Step 403: Send a wireless communication signal that carries the acknowledgement information.

The wireless communications module of the terminal sends the wireless communication signal that carries the acknowledgement information transmitted by the LLC entity module of the terminal.

Preferably, the wireless communication signal is a WiFi signal, a Bluetooth signal, or an IR signal; or the wireless communication signal is a cellular wireless communication signal.

In specific implementation, if the terminal directly feeds back the acknowledgement information to the VLC device, a wireless communication signal type may be selected according to an agreement between the terminal and the VLC device. If both the terminal and the VLC device support WiFi, the wireless communication signal may be a WiFi signal; if both the terminal and the VLC device support Bluetooth, the wireless communication signal may be a Bluetooth signal; if both the terminal and the VLC device support IR, the wireless communication signal may be an IR signal; or if both the terminal and the VLC device support cellular wireless communication, the wireless communication signal may be a cellular wireless communication signal.

In specific implementation, if the terminal transmits the acknowledgement information to the VLC device by means of forwarding by a wireless communications device, the wireless communications device and a corresponding wireless communication signal type may be selected according to a capability of the terminal. For example, if the terminal has a cellular wireless communication capability, a cellular wireless communications access point device may forward the acknowledgement information to the VLC device. The cellular wireless communications access point device may be a small cell, a femto cell, or a high-frequency base station.

Preferably, if the VLC device has a wireless communication function, the terminal may directly send the wireless communication signal to the VLC device, that is, the terminal sends the wireless communication signal that carries the acknowledgement information to the visible light communications device.

Preferably, if the VLC device does not have a wireless communication function, the wireless communication signal sent by the terminal is forwarded by the wireless communications device to the VLC device, and a specific process is as disclosed in the following steps.

The terminal sends the wireless communication signal that carries the acknowledgement information to the wireless communications device, and the wireless communications device forwards the acknowledgement information to the VLC device.

A communications link between the wireless communications device and the VLC device may be any one of an Ethernet communications link, a power line communications link, or a wireless communications link.

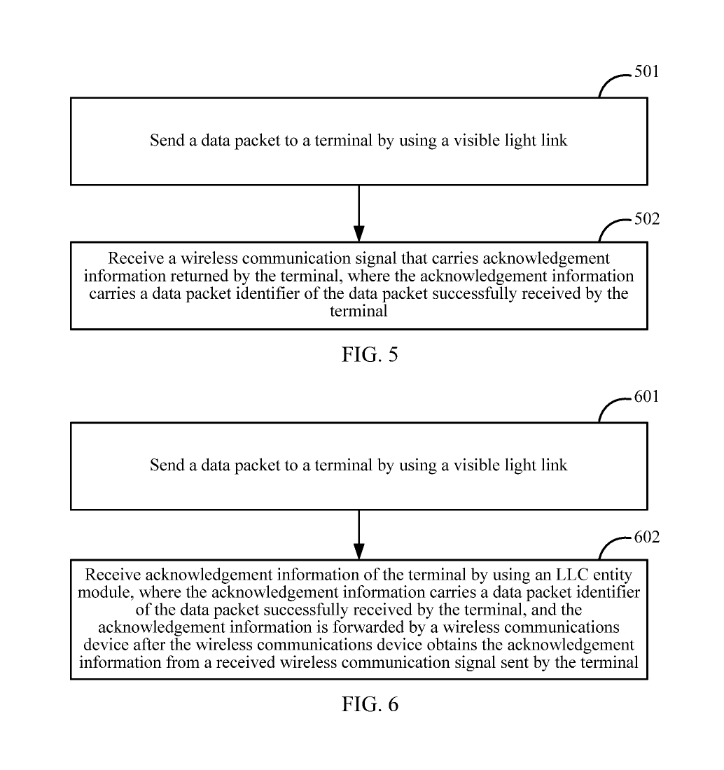

In a fifth embodiment of the present disclosure, as shown in FIG. 5, an execution body may be but is not limited to a VLC device, and the VLC device has a wireless communication capability, that is, the VLC device is equivalent to the VLC device provided in the second embodiment. A detailed process of a method for implementing, by the VLC device, visible light communication is as disclosed in the following steps.

Step 501: Send a data packet to a terminal using a visible light link.

A VLC transmit module of the VLC device transmits the data packet to the terminal using the visible light link, where the data packet carries a data packet identifier.

Step 502: Receive a wireless communication signal that carries acknowledgement information returned by the terminal, where the acknowledgement information carries a data packet identifier of the data packet successfully received by the terminal.

A wireless communications module of the VLC device receives the wireless communication signal returned by the terminal, where the wireless communication signal carries the acknowledgement information returned by the terminal, and the acknowledgement information carries the data packet identifier of the data packet successfully received by the terminal.

The wireless communications module of the VLC device transmits the acknowledgement information to an LLC entity module of the VLC device; the LLC entity module of the VLC device obtains, according to the acknowledgement information, the data packet identifier of the data packet successfully received by the terminal, and transmits the obtained data packet identifier to the VLC transmit module of the VLC device; and the VLC transmit module of the VLC device transmits a data packet to the terminal using the visible light link, where the transmitted data packet does not include the data packet that corresponds to the data packet identifier transmitted by the LLC entity module of the VLC device.

Preferably, the wireless communication signal is a WiFi signal, a Bluetooth signal, or an IR signal.

Preferably, the VLC device obtains the data packet identifier carried in the acknowledgement information, and sends a data packet to the terminal, where the sent data packet does not include the data packet corresponding to the obtained data packet identifier.

In a sixth embodiment of the present disclosure, as shown in FIG. 6, an execution body may be but is not limited to a VLC device, and the VLC device does not have a wireless communication capability. A detailed process of a method for implementing, by the VLC device, visible light communication is as disclosed in the following steps.

Step 601: Send a data packet to a terminal using a visible light link.

A VLC transmit module of the VLC device transmits the data packet to the terminal using the visible light link, where the data packet carries a data packet identifier.

Step 602: Receive acknowledgement information of the terminal using an LLC entity module, where the acknowledgement information carries a data packet identifier of the data packet successfully received by the terminal, and the acknowledgement information is forwarded by a wireless communications device after the wireless communications device obtains the acknowledgement information from a received wireless communication signal sent by the terminal.

The LLC entity module of the VLC device receives an acknowledgement notification message sent by the wireless communications device, obtains the data packet identifier that is carried in the acknowledgement information and that is of the data packet successfully received by the terminal, and transmits the obtained data packet identifier to the VLC transmit module of the VLC device.

A communications link between the VLC device and the wireless communications device may be any one of an Ethernet communications link, a power line communications link, or a wireless communications link.

The VLC transmit module of the VLC device transmits a data packet to the terminal using the visible light link, where the transmitted data packet does not include the data packet that corresponds to the data packet identifier transmitted by the LLC entity module of the VLC device.

Preferably, the wireless communications device obtains the acknowledgement information from a received WiFi signal, Bluetooth signal, or IR signal that is sent by the terminal; or the wireless communications device obtains the acknowledgement information from a received cellular wireless communication signal sent by the terminal.

In specific implementation, the wireless communications device and a wireless communication signal type corresponding to the wireless communications device are selected according to a capability of terminal.

For example, if the terminal has a cellular wireless communication capability, a cellular wireless communications access point device may forward the acknowledgement information to the VLC device. The cellular wireless communications access point device may be a small cell, a femto cell, or a high-frequency base station.

For another example, if the terminal has a WiFi communication capability, a device having a WiFi function may forward the acknowledgement information to the VLC device.

The following describes a detailed process of bidirectional visible light communication using two specific embodiments.

The following specific embodiments are described using an example in which a VLC device is a VLC lamp.

The following specific embodiments are described using only an example in which a wireless communications device is a short range wireless communications device having a short range wireless communication capability and a wireless communication signal is a short range wireless communication signal (for example, WiFi).

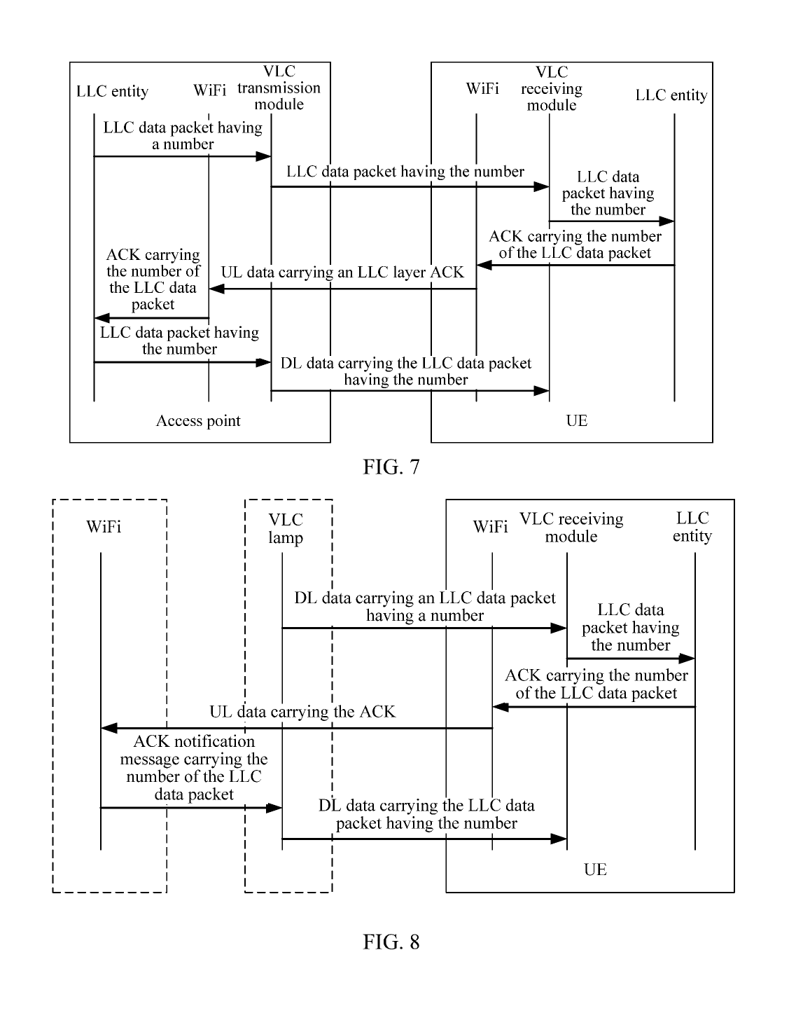

In a first specific embodiment, the VLC lamp and the short range wireless communication function are integrated in one access point device. As shown in FIG. 7, the access point device includes both a VLC transmit module (including a MAC layer, a physical layer, and a light-emitting component) and a short range wireless communications module, such as a WiFi module, a Bluetooth module, or an IR module.

This specific embodiment is described using an example in which WiFi is used to implement short range wireless communication. A method in which Bluetooth or IR is used to perform short range wireless communication is similar to the method in which WiFi is used, and details are not described herein again.

In this specific embodiment, a number of an LLC data packet is used as a data packet identifier.

When DL data of a user equipment arrives at the access point device, an LLC entity module of the access point device converts the DL data into an LLC data packet having a number, and transmits the LLC data packet to the VLC transmit module, and the VLC transmit module sends the LLC data packet to the user equipment using the VLC lamp.

After receiving the DL data, a VLC receiving module of the user equipment delivers the LLC data packet carried in the successfully received DL data to the LLC entity module. After receiving the LLC data packet, the LLC entity module of the UE sends an LLC layer ACK message to the access point device using a WiFi module of the UE, where the LLC layer ACK message includes information about the number of the LLC data packet that is successfully received by the UE using the VLC receiving module.

After receiving uplink (UL) data including the LLC layer ACK message, the WiFi module of the access point device delivers the ACK message to the LLC entity module. The LLC entity module of the access point device learns, according to the number that is included in the ACK message and that is of the LLC data packet, DL data successfully received by the user, and accordingly determines whether a DL data packet needs to be retransmitted.

For data needing to be retransmitted, a same LLC data packet number used in initial transmission is still used, and the access point device sends the data to the user equipment using the VLC transmit module. For new data, a new LLC data packet number is used and the data is sent to the user equipment using the VLC transmit module.

In a second specific embodiment, the VLC lamp and the short range wireless communication function belong to two different devices. As shown in FIG. 8, the VLC lamp has a VLC data sending capability. A short range wireless communications access point having a short range wireless communication function may be a WiFi access point (AP), a Bluetooth device, or an IR device, and the VLC lamp may communicate with the short range wireless communications access point in a manner of Ethernet, a power line, wireless, or the like.

This specific embodiment is described using an example in which WiFi is used to implement short range wireless communication. A method in which Bluetooth or IR is used to perform short range wireless communication is similar to the method in which WiFi is used, and details are not described herein again.

In this specific embodiment, a number of an LLC data packet is used as a data packet identifier.

When DL data of a user arrives at the VLC lamp, an LLC entity module of the VLC lamp converts the DL data into an LLC data packet having a number, and a VLC transmit module sends DL data carrying the LLC data packet to the user equipment using a VLC link.

After receiving the DL data, a VLC receiving module of the user equipment delivers the LLC data packet carried in the successfully received DL data to an LLC entity module of the user equipment. After receiving the LLC data packet, the LLC entity module of the UE sends an LLC layer ACK message to the WiFi AP using a WiFi module of the UE, where the LLC layer ACK message includes information about the number of the LLC data packet that is successfully received by the UE using the VLC receiving module.

After receiving UL data including the LLC layer ACK message, the WiFi AP sends an ACK notification message to the VLC lamp, where the ACK notification message includes the number that is included in the LLC layer ACK message and that is of the LLC data packet.

The VLC lamp learns, according to the number that is included in the ACK notification message and that is of the LLC data packet, DL data successfully received by the user, and accordingly determines whether a DL data packet needs to be retransmitted. For data needing to be retransmitted, a same LLC data packet number used in initial transmission is still used, and the data is sent to the user equipment using the VLC transmit module. For new data, a new LLC data packet number is used, and the data is sent to the user equipment using the VLC transmit module.

Based on the foregoing technical solutions, in the embodiments of the present disclosure, in a scenario of visible light communication, a terminal feeds back uplink data to a visible light communications device using a wireless communication signal, so that in a case in which the terminal can receive only visible light data, the terminal can feed back data to the VLC device, thereby implementing bidirectional data transmission. Therefore, a communication rate of an access point is increased using visible light frequency spectrum resources, and a data service requirement of a user can be better satisfied.

A person skilled in the art should understand that the embodiments of the present disclosure may be provided as a method, a system, or a computer program product. Therefore, the present disclosure may use a form of hardware only embodiments, software only embodiments, or embodiments with a combination of software and hardware. Moreover, the present disclosure may use a form of a computer program product that is implemented on one or more computer-usable storage media (including but not limited to a disk memory, an optical memory, and the like) that include computer-usable program code.

The present disclosure is described with reference to the flowcharts and/or block diagrams of the method, the device (system), and the computer program product according to the embodiments of the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may also be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Obviously, a person skilled in the art can make various modifications and variations to the present disclosure without departing from the spirit and scope of the present disclosure. The present disclosure is intended to cover these modifications and variations provided that they fall within the scope of protection defined by the following claims and their equivalent technologies.

What is claimed is:

1. A terminal, comprising:
a visible light communications (VLC) receiver configured to receive a data packet that is transmitted using a visible light link, wherein the data packet carries a data packet identifier;
a logical link control (LLC) entity module configured to generate acknowledgement information according to the data packet received by the VLC receiving module, wherein the acknowledgement information carries the data packet identifier of the successfully received data packet; and
a wireless transmitter configured to send a wireless communication signal that carries the acknowledgement information generated by the LLC entity module.

2. The terminal according to claim 1, wherein the wireless transmitter is configured to:
send a WiFi signal, a Bluetooth signal, or an infra-red (IR) signal carrying the acknowledgement information generated by the LLC entity module; or
send a cellular wireless communication signal carrying the acknowledgement information generated by the LLC entity module.

3. A visible light communications (VLC) device, comprising:
a communications receiver configured to receive a communication signal carrying acknowledgement information, wherein the acknowledgement information carries a data packet identifier of a data packet that is successfully received by a terminal and that is transmitted using a visible light link;
a logical link control (LLC) entity module configured to obtain, according to the acknowledgement information received by the communications receiver, the data packet identifier of the data packet successfully received by the terminal; and
a VLC transmitter configured to transmit a data packet to the terminal using the visible light link, wherein the transmitted data packet does not comprise the data packet that corresponds to the data packet identifier obtained by the LLC entity module.

4. The device according to claim 3, wherein the communications receiver is configured to:
receive a WiFi signal, a Bluetooth signal, or an infra-red (IR) signal carrying the acknowledgement information; or
receive a cellular wireless communication signal carrying the acknowledgement information.

5. The device according to claim 3, wherein the communications receiver is configured to receive an acknowledgement notification message that is sent by a wireless communications device and carrying the acknowledgement information, wherein the acknowledgement information carries the data packet identifier of the data packet that is successfully received by the terminal and that is transmitted using the visible light link, and wherein the acknowledgement notification message is generated and sent by the wireless communications device after the wireless communications device receives a wireless communication signal that is sent by the terminal and carrying the acknowledgement information.

6. The device according to claim 5, wherein the communications receiver is connected to the wireless communications device using any one of an Ethernet communications link, a power line communications link, or a wireless communications link.

7. A wireless communications device, comprising:
a receiver configured to:
receive a wireless communication signal that is sent by a terminal and carrying acknowledgement information, wherein the acknowledgement information carries a data packet identifier of a data packet that is successfully received by the terminal and that is transmitted using a visible light link; and
obtain the acknowledgement information;
a logical link control (LLC) entity module configured to:
obtain the data packet identifier that is carried in the acknowledgement information obtained by the receiver; and
generate an acknowledgement notification message carrying the obtained data packet identifier; and
a transmitter configured to send the acknowledgement notification message generated by the LLC entity module to a visible light communications device.

8. The wireless communications device according to claim 7, wherein the receiver is further configured to:
receive a WiFi signal, a Bluetooth signal, or an infra-red (IR) signal that is sent by the terminal and carrying the acknowledgement information; or
receive a cellular wireless communication signal that is sent by the terminal and carrying the acknowledgement information.

9. The wireless communications device according to claim 7, wherein the wireless communications device has at least one of a WiFi function a Bluetooth function an IR function, or a cellular wireless communication capability.

10. A visible light communication method, comprising:
receiving a data packet that is transmitted by a visible light communications device using a visible light link, wherein the data packet carries a data packet identifier;
generating acknowledgement information according to the successfully received data packet, wherein the acknowledgement information carries the data packet identifier of the successfully received data packet; and
sending a wireless communication signal carrying the acknowledgement information.

11. The method according to claim 10, wherein sending the wireless communication signal carrying the acknowledgement information comprises:
sending a WiFi signal, a Bluetooth signal, or an infra-red (IR) signal carrying the acknowledgement information; or
sending a cellular wireless communication signal carrying the acknowledgement information.

12. The method according to claim 10, wherein sending the wireless communication signal carrying the acknowledgement information comprises:
sending the wireless communication signal carrying the acknowledgement information to a wireless communications device, such that the wireless communications device forwards the acknowledgement information to the visible light communications device; or
sending the wireless communication signal carrying the acknowledgement information to the visible light communications device.

13. A visible light communication method, comprising:
sending a data packet to a terminal using a visible light link; and
receiving a wireless communication signal carrying acknowledgement information returned by the terminal, wherein the acknowledgement information carries a data packet identifier of the data packet successfully received by the terminal.

14. The method according to claim 13, wherein receiving the wireless communication signal carrying acknowledgement information returned by the terminal comprises:
receiving a WiFi signal, a Bluetooth signal, or an infra-red (IR) signal carrying the acknowledgement information returned by the terminal; or
receiving a cellular wireless communication signal carrying the acknowledgement information returned by the terminal.

15. The method according to claim 13, further comprising:
obtaining the data packet identifier carried in the acknowledgement information; and
sending a data packet to the terminal, wherein the sent data packet does not comprise the data packet corresponding to the obtained data packet identifier.

16. A visible light communication method, comprising:
sending a data packet to a terminal using a visible light link; and
receiving acknowledgement information of the terminal using a logical link control entity, wherein the acknowledgement information carries a data packet identifier of the data packet successfully received by the terminal, and wherein the acknowledgement information is forwarded by a wireless communications device after the wireless communications device obtains the acknowledgement information from a received wireless communication signal sent by the terminal.

17. The method according to claim 16, wherein obtaining, by the wireless communications device, the acknowledgement information from the received wireless communication signal sent by the terminal comprises:
obtaining, by the wireless communications device, the acknowledgement information from a received WiFi signal, Bluetooth signal, or infra-red (IR) signal that is sent by the terminal; or
obtaining, by the wireless communications device, the acknowledgement information from a received cellular wireless communication signal sent by the terminal.

18. The method according to claim 16, wherein forwarding, by the wireless communications device, the acknowledgement information after obtaining the acknowledgement information from the received wireless communication signal sent by the terminal comprises forwarding, by the wireless communications device, the acknowledgement information using any one of an Ethernet communications link, a power line communications link, or a wireless communications link.

19. The wireless communications device according to claim 8, wherein the wireless communications device has a WiFi function, a Bluetooth function, an IR function; or a cellular wireless communication capability.

20. The method according to claim 11, wherein sending the wireless communication signal carrying the acknowledgement information comprises:
sending the wireless communication signal carrying the acknowledgement information to a wireless communications device, such that the wireless communications device forwards the acknowledgement information to the visible light communications device; or
sending the wireless communication signal carrying the acknowledgement information to the visible light communications device.
